(19) United States
(12) Patent Application Publication
(10) Pub. No.: US 2008/0307169 A1
(43) Pub. Date: Dec. 11, 2008

(54) Method, Apparatus, System and Program Product Supporting Improved Access Latency for a Sectored Directory

(76) Inventors: Duane Arlyn Averill, Rochester, MN (US); Jonathon C. Skarphol, Cedar Rapids, IA (US); Brian T. Vanderpool, Byron, MN (US)

Correspondence Address: IBM CORPORATION, 3605 HIGHWAY 52 NORTH, DEPT 917, ROCHESTER, MN, 55901-7829, US

(21) Appl. No.: 11/758,851

(22) Filed: Jun. 6, 2007

(51) Int. Cl. G06F 12/08

(52) U.S. Cl. 711/146; 711/E12.057

(57) ABSTRACT

A data processing system includes a coherence directory having a prefetch sector cache and a memory directory array containing a plurality of sectored entries. According to one method, in response to receiving a first directory lookup request specifying a first target address, an entry associated with the target address is accessed in the memory directory array. In response to the access, the coherence directory returns, as a result of the first directory lookup request, contents of a first sector that is identified by the target address as a requested sector. The coherence directory also caches contents of a second sector of the multiple sectors that is a non-requested sector for the first directory lookup request in a prefetch sector cache. In response to receiving a subsequent second directory lookup request specifying a second target address that identifies the second sector as a requested sector, the coherence directory accesses the contents of the second sector in the sector prefetch cache and returns the contents of the second sector as a result of the second directory lookup request.

### BACKGROUND OF THE INVENTION

1. Technical Field

The present invention relates in general to data processing and, in particular, to cache coherent multiprocessor data processing systems employing directory-based coherency protocols.

2. Description of the Related Art

In one conventional multiprocessor computer system architecture, a Northbridge memory controller supports the connection of multiple processor buses, each of which has a one or more sockets supporting the connection of a processor. Each processor typically includes an on-die multi-level cache hierarchy providing low latency access to memory blocks that are likely to be accessed. The Northbridge memory controller also includes a memory interface supporting connection of system memory (e.g., Dynamic Random Access Memory (DRAM)).

A coherent view of the contents of system memory is maintained in the presence of potentially multiple cached copies of individual memory blocks distributed throughout the computer system through the implementation of a coherency protocol. The coherency protocol, for example, the well-known Modified, Exclusive, Shared, Invalid (MESI) protocol, entails maintaining state information associated with each cached copy of a memory block and communicating at least some memory access requests between processors to make the memory access requests visible to other processors.

As is well known in the art, the coherency protocol may be implemented either as a directory-based protocol having a generally centralized point of coherency (i.e., the memory controller) or as a snoop-based protocol having distributed points of coherency (i.e., the processors). Because a directory-based coherency protocol reduces the number of processor memory access requests must be communicated to other processors as compared with a snoop-based protocol, a directory-based coherency protocol is often selected in order to preserve bandwidth on the processor buses.

In most implementations of the directory-based coherency protocols, the coherency directory maintained by the memory controller is somewhat imprecise, meaning that the coherency state recorded at the coherency directory for a given memory block may not precisely reflect the coherency state of the corresponding cache line at a particular processor at a given point in time. Such imprecision may result, for example, from a processor “silently” deallocating a cache line without notifying the coherency directory of the memory controller. The coherency directory may also not precisely reflect the coherency state of a cache line at a processor at a given point in time due to latency between when a memory access request is received at a processor and when the resulting coherency update is recorded in the coherency directory. Of course, for correctness, the imprecise coherency state indication maintained in the coherency directory must always reflect a coherency state sufficient to trigger the communication necessary to maintain coherency, even if that communication is in fact unnecessary for some dynamic operating scenarios. For example, assuming the MESI coherency protocol, the coherency directory may indicate the E state for a cache line at a particular processor, when the cache line is actually S or I. Such imprecision may cause unnecessary communication on the processor buses, but will not lead to any coherency violation.

Because the working data sets of processors and thus the size of processor caches continue to grow in size, some coherency directories now employ sectoring to permit larger processor caches without a like increase in cache directory size. With sectoring, each directory entry in the coherency directory contains multiple sectors that can be manipulated and managed individually. For example, the memory block corresponding to one sector of a directory entry could be present in a processor cache and the memory block corresponding to a second sector might not be cached. However, to reduce directory storage, a single address field is associated with all sectors of the directory entry. Consequently, with sectoring, a similar number of directory entries can support larger processor caches in the same cache directory area than would be possible with a non-sectored implementation.

### SUMMARY OF THE INVENTION

The present invention provides improved methods, apparatus, systems and program products. In one embodiment, a data processing system includes a coherence directory having a prefetch sector cache and a memory directory array containing a plurality of sectored entries. According to one method, in response to receiving a first directory lookup request specifying a first target address, an entry associated with the target address is accessed in the memory directory array. In response to the access, the coherence directory returns, as a result of the first directory lookup request, contents of a first sector that is identified by the target address as a requested sector. The coherence directory also caches contents of a second sector of the multiple sectors that is a non-requested sector for the first directory lookup request in a prefetch sector cache. In response to receiving a subsequent second directory lookup request specifying a second target address that identifies the second sector as a requested sector, the coherence directory accesses the contents of the second sector in the sector prefetch cache and returns the contents of the second sector as a result of the second directory lookup request.

All objects, features, and advantages of the present invention will become apparent in the following detailed written description.

### BRIEF DESCRIPTION OF THE DRAWINGS

The novel features believed characteristic of the invention are set forth in the appended claims. However, the invention, as well as a preferred mode of use, will best be understood by reference to the following detailed description of an illustrative embodiment when read in conjunction with the accompanying drawings, wherein:

FIG. 1 is a high level block diagram of an exemplary data processing system in accordance with the present invention;

FIG. 2 is a more detailed block diagram of the chipset coherency unit (CCU) of FIG. 1;

FIG. 3A illustrates an exemplary format of a pending queue (PQ) entry within the CCU of FIG. 2 in accordance with the present invention;

FIG. 3B depicts an exemplary embodiment of the coherence directory of FIG. 2 in accordance with the present invention;

FIGS. 4A-4B together form a high level logical flowchart of an exemplary method of processing a memory access request of a processor in accordance with the present invention; and

FIGS. 5A-5B together form a high level logical flowchart of a method of accessing a coherence directory of a data processing system employing a directory-based coherency protocol in accordance with the present invention.

### DETAILED DESCRIPTION OF ILLUSTRATIVE EMBODIMENT

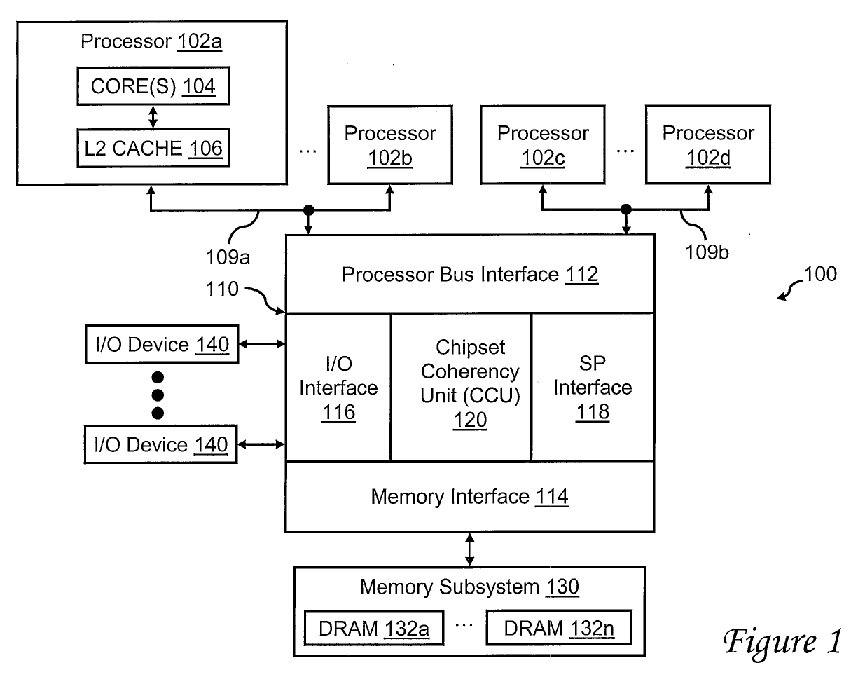

With reference now to the figures, wherein like reference numerals refer to like and corresponding parts throughout, and in particular with reference to FIG. 1, there is illustrated a high-level block diagram depicting an exemplary cache coherent multiprocessor data processing system 100 in accordance with the present invention. As shown, data processing system 100 includes multiple processors 102 (in the exemplary embodiment, at least processors 102a, 102b, 102c and 102d) for processing data and instructions. In the depicted embodiment, processors 102, which are formed of integrated circuitry, each include a level two (L2) cache 106 and one or more processing cores 104 each having an integrated level one (L1) cache (not illustrated). As is well known in the art, L2 cache 106 includes a data array (not illustrated), as well as a cache directory (not illustrated) that maintains coherency state information for each cache line or cache line sector cached within the data array. In an exemplary embodiment, the possible coherency states of cache lines held in L2 cache 106 include the Modified, Exclusive, Shared and Invalid states of the well-known MESI protocol. Of course in other embodiments, other coherency protocols may be employed.

Each processor 102 is further connected to a socket on a respective one of multiple processor buses 109 (e.g., processor bus 109a or processor bus 109b) that conveys address, data and coherency/control information. In one embodiment, communication on each processor bus 109 is governed by a conventional bus protocol that organizes the communication into distinct time-division multiplexed phases, including a request phase, a snoop phase, and a data phase.

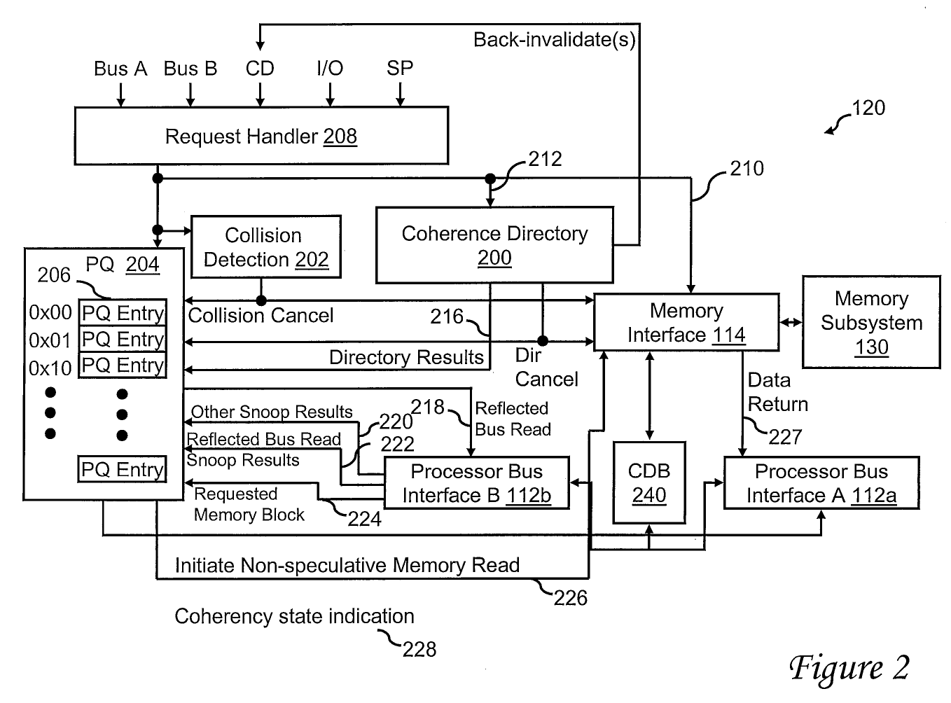

As further depicted in FIG. 1, data processing system 100 further includes a Northbridge memory controller 110. Memory controller 110, which is preferably realized as a single integrated circuit, includes a processor bus interface 112 that is connected to each processor bus 109 and that supports communication with processors 102 via processor buses 109. As indicated in FIG. 2, processor bus interface 112 preferably includes a separate instance of data buffering and bus communication logic (i.e., processor bus interface 112a, 112b as shown in FIG. 2) for each processor bus 109. Data received by each processor bus interface 112a, 112b for transmission to a processor 102 is buffered until the data is validated, and is thereafter transmitted to over the appropriate processor bus 109. The data validation may arrive before or after the data to be transmitted.

Memory controller 110 further includes a memory interface 114 that controls access to a memory subsystem 130 containing memory devices such as Dynamic Random Access Memories (DRAMs) 132a-132n, an input/output (I/O) interface 116 that manages communication with I/O devices 140, and a Scalability Port (SP) interface 118 that supports attachment of multiple computer systems to form a large scalable system. Memory controller 110 finally includes a chipset coherency unit (CCU) 120 that maintains memory coherency in data processing system 100 by implementing a directory-based coherency protocol, as discussed below in greater detail.

Those skilled in the art will appreciate that data processing system 100 of FIG. 1 can include many additional non-illustrated components, such as interconnect bridges, non-volatile storage, ports for connection to networks, etc. Because such additional components are not necessary for an understanding of the present invention, they are not illustrated in FIG. 1 or discussed further herein.

Referring now to FIG. 2, a more detailed block diagram of an exemplary embodiment of the chipset coherency unit (CCU) 120 of memory controller 110 of FIG. 1 is depicted with reference to other components of data processing system 100. As shown, CCU 120 includes a coherence directory 200 that records a respective coherency state for each processor 102 in association with the memory address of each memory block cached by any of processors 102 (i.e., coherence directory 200 is inclusive of the contents of L2 caches 106).

CCU 120 further includes collision detection logic 202 that detects and signals collisions between memory access requests and a request handler 208 that serves as a point of serialization for memory access and coherency update requests received by CCU 120 from processor buses 109a, 109b, coherence directory 200, I/O interface 116, and SP 118. CCU 120 also includes a pending queue (PQ) 204 for processing requests. PQ 204 includes a plurality of PQ entries 206 for buffering memory access and coherency update requests until serviced. As indicated, each PQ entry 206 has an associated key (e.g., 0x00, 0x01, 0x10, etc.) uniquely identifying that PQ entry 206. PQ 204 includes logic for appropriately processing the memory access and coherency update requests to service the memory access requests and maintain memory coherency. Finally, CCU 120 includes a central data buffer (CDB) 240 that buffers memory blocks associated with pending memory access requests.

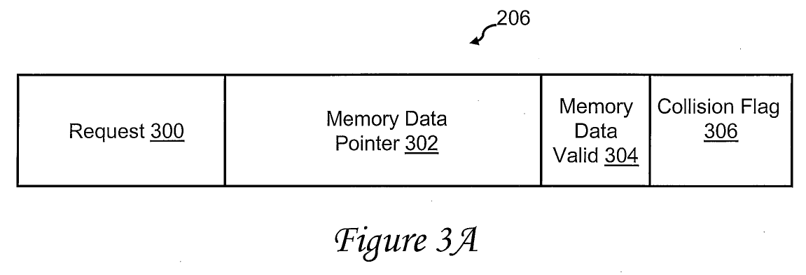

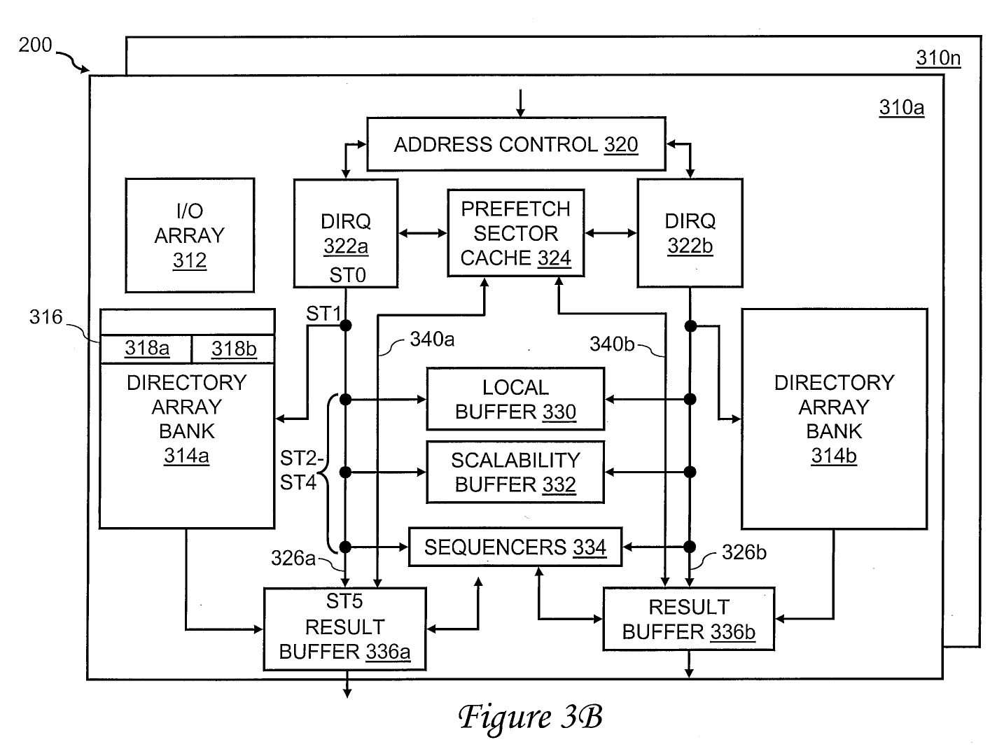

With reference now to FIG. 3A, there is illustrated an exemplary embodiment of a pending queue (PQ) entry 206 within CCU 120 of FIG. 2 in accordance with the present invention. In the depicted embodiment, PQ entry 206 includes a request field 300 for buffering the pending memory access or coherency update request to which PQ entry 206 is allocated, a memory data pointer field 302 for identifying a location within a central data buffer (CDB) 240 (see FIG. 2) in which a memory block read from or to be written to memory subsystem 130 by the memory access request is buffered, and a memory data valid field 304 indicating whether or not the content of indicated location within CDB 240 is valid. In at least one embodiment of the present invention, PQ entry 206 further includes a collision flag 306 that provides an indication of whether or not an address collision has occurred for the memory access request to which PQ entry 206 is allocated.

Referring now to FIG. 3B, there is depicted a more detailed view of an embodiment of coherence directory 200 in accordance with the present invention. In the depicted embodiment, coherence directory 200 includes multiple identical directory “slices” 310a-310n, which are each responsible for tracking coherency states for a respective set of addresses within memory subsystem 130 and the I/O address space employed by I/O devices 140.

Each directory slice 310 includes an I/O array 312 for tracking the coherency of a respective set of I/O addresses, as well as a memory directory array for tracking the coherency of a respective set of real memory addresses within memory subsystem 130. In the depicted embodiment, the memory directory array is implemented with a pair of directory array banks 314a-314b (but in other embodiments could include additional banks). Each directory array bank 314 includes a plurality of directory entries 316 (only one of which is shown) for storing coherency information for a respective subset of the real memory addresses assigned to its slice 310. For example, in one embodiment, target real memory addresses corresponding to odd multiples of the memory block size (e.g., 128) are queued in directory array bank 314a, and target real memory addresses corresponding to even multiples of the memory block size are queued in directory array bank 314b. Even though in practical implementations the memory directory array has fewer entries 316 that the number of memory blocks in memory subsystem 130, the memory directory array can be very large. Consequently, directory array banks 314 typically exhibit multi-cycle access latency and are implemented in typical commercial applications with a cost-effective (albeit slower) memory technology, such as embedded dynamic access random access memory (eDRAM).

Each directory entry 316 comprises multiple (in this case, two) sectors 318a and 318b. Thus, for example, if each directory entry 316 is associated with a 128-byte memory block, sector 318a provides coherency state information for the first 64 bytes of the 128-byte memory block and sector 318b provides coherency state information for the last 64 bytes of the 128-byte memory block. In an exemplary embodiment, the possible coherency states that may be recorded in sectors 318a-318b are only a subset of the possible cache coherency states and include the Exclusive, Shared and Invalid states of the MESI protocol.

Each directory slice 310 also includes address control logic 320, which initially receives requests of processors 102 and I/O devices 140 and determines by reference to the request addresses specified by the requests whether the requests are to be handled by that directory slice 310. If a request is a memory access request, address control logic 320 also determines which of directory array banks 314 holds the relevant coherency information and dispatches the request to the appropriate one of directory queues (DIRQs) 322a, 322b for processing.

Directory queues 322a, 322b are each coupled to a prefetch sector cache 324, which in a preferred embodiment is a small (e.g., 16-32 entry) storage area for caching non-requested sectors 318 of directory entries 316 accessed in directory array banks 314. To promote rapid access times, prefetch sector cache 324 is preferably implemented as latches or other high-speed storage circuitry. Because non-requested sectors 318 exhibit good temporal locality in that they are frequently requested following an access to the other sector in the same directory entry 316, caching such non-requested sectors 318 in prefetch sector cache 324 reduces overall coherence directory access latency, as described further below.

To maintain a small footprint, prefetch sector cache 324 preferably implements a simple replacement policy requiring minimal circuitry. For example, because prefetch sector cache 324 is design to leverage temporal locality of reference, a First-In, First-Out (FIFO) policy can be used to evict entries from prefetch sector cache 324 in response to new requests. A variety of techniques may also be employed in accordance with the present invention in order to maintain coherency within prefetch sector cache 324 in the presence of updates to directory array banks 314. In a preferred embodiment, directory queues 322 simply invalidate the coherency information in prefetch sector cache 324 of any sector 318 that is the subject of a directory update.

Directory queues 322a, 322b are each further coupled to a respective directory pipeline 326a or 326b. Each directory pipeline 326 initiates access, as needed, to its directory array bank 314, a local buffer 330 that buffers sectors 318 recently requested by local processors 102, a scalability buffer 332 that buffers sectors 318 recently requested by processors 102 in other nodes coupled to memory controller 110 via its scalability port interface 118, and a pool of sequencers 334 responsible for implementing a selected replacement policy for the entries 316 in directory array banks 314. Directory pipelines 326 each terminate in a respective one of result buffers 336a, 336b, which return requested coherency information retrieved from prefetch sector cache 324, directory array bank 314, local buffer 330 or scalability buffer 332 to PQ 204 and further transmit back-invalidation commands to request handler 208 (as shown in FIG. 2).

In the depicted embodiment, directory pipelines 326 are implemented with multiple stages of logic (stage 0 through stage 5) that sequentially process directory lookup requests. The duration of processing a directory lookup request in a directory pipeline 326 is preferably designed such that directory lookup request traverses the directory pipeline 326 in the time required to access a memory array bank 314.

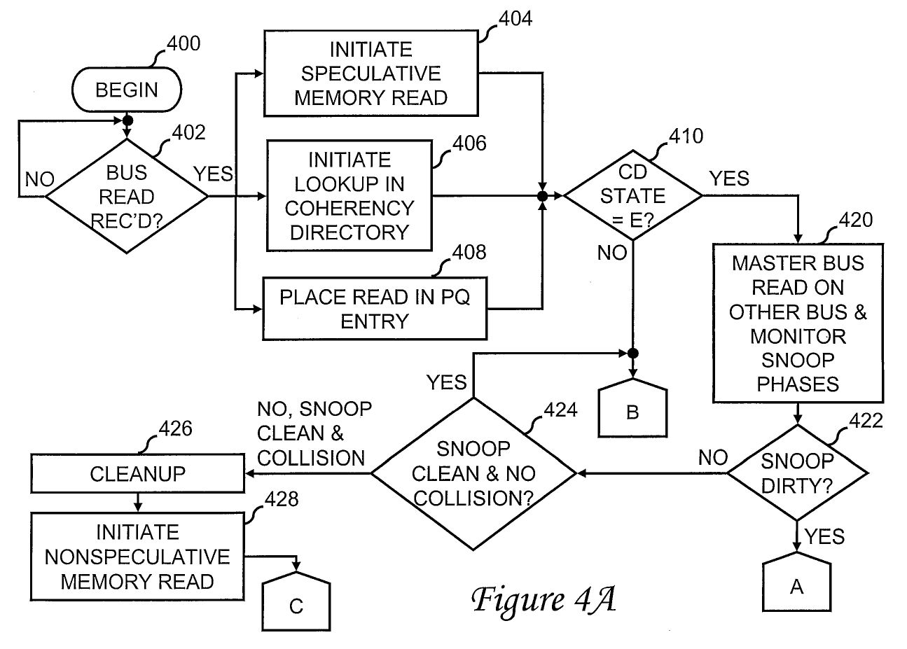

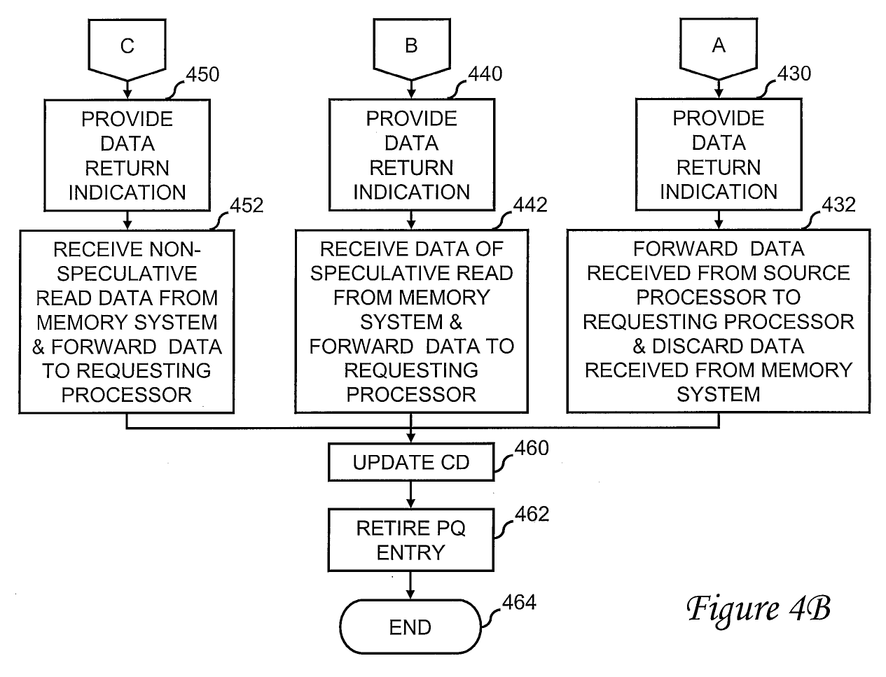

With reference now to FIGS. 4A-4B, there is illustrated a high level logical flowchart of an exemplary method of processing a memory access request (e.g., a bus read request) of a processor in a data processing system 100 in accordance with the present invention. In accordance with the present invention, overall memory access latency is reduced by reducing coherence directory access latency utilizing prefetch sector cache 324. As with the other logical flowcharts described herein, at least some of the illustrated operations may be performed concurrently or in a different order than that depicted.

The illustrated process begins at block 400 and proceeds to block 402, which depicts memory controller 110 determining if it has received a bus read request from a processor 102. If not, the process iterates at block 402 until a bus read request is received. In response to receipt of a bus read request, which includes a transaction type indication and specifies the target memory address of a target memory block to be read, the process proceeds to blocks 404-408. For ease of explanation, it will be assumed hereafter that the bus read request is received by processing bus interface 112a via processor bus 109a.

Block 404 illustrates request handler 208 transmitting the target memory address of the bus read request to memory interface 114 to initiate a speculative (fast path) read of the memory block associated with the target memory address from memory subsystem 130, as also shown at reference numeral 210 of FIG. 2. The read of the memory block from memory subsystem 130 is speculative in that, in order to mask access latency, the fast path read is initiated prior to determining whether or not memory subsystem 130 contains the most recent copy of the requested memory block or whether the most recent copy of the memory block is cached by one of processors 102.

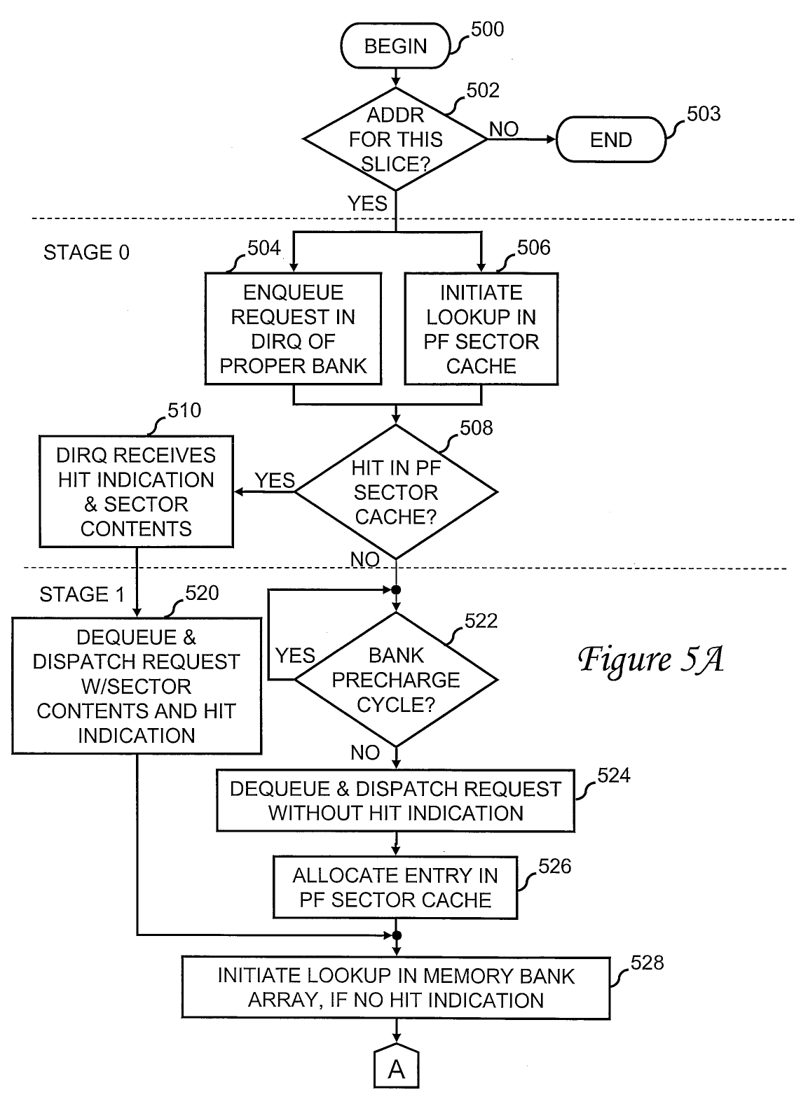

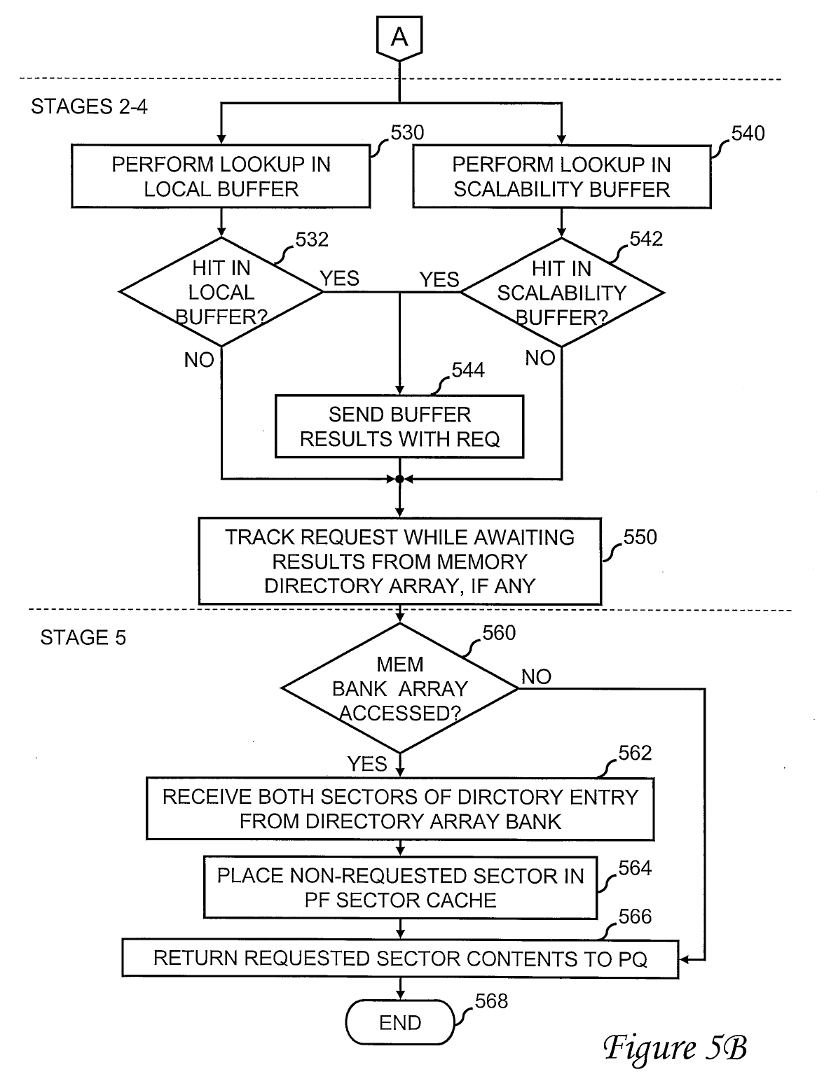

Block 406 depicts request handler 208 transmitting the target memory address of the bus read request along with an indication of the request source to coherence directory 200 to initiate a lookup of the coherency state associated with target memory address in coherence directory 200, as also shown at reference numeral 212 of FIG. 2. The operation of coherence directory 200 in response to receipt of the directory lookup request is described in detail below with reference to FIG. 5.

Block 408 illustrates PQ 204 allocating a PQ entry 206 for the memory access request and placing the memory access request in the request field 300 of the allocated PQ entry 206. Allocation of PQ entry 206 associates the memory access request with the key of the allocated PQ entry 206.

The process proceeds from blocks 404, 406 and 408 to block 410, which depicts PQ 204 receiving from coherence directory 200 the coherency states of the processors 102 with respect to the target memory address of the memory access request (as also shown at reference numeral 216 of FIG. 2). PQ 204 thereafter processes the memory access request in accordance with the coherency state information in order to service the memory access request while preserving memory coherency. Thus, if PQ 204 determines at block 410 that coherence directory 200 indicates the coherency state for the requested memory block is not Exclusive (E) for any processor 102, that is, is Shared (S) or Invalid (I) for all processors 102, the process passes through page connector B to block 440 of FIG. 4B, which is described below. If, on the other hand, PQ 204 determines at block 410 that coherence directory 204 indicates the coherency state of the requested memory block is Exclusive (E) for a particular processor 102, meaning that the memory block may be in any of the M, E, S or I states with respect to that processor 102, the process passes to block 420. It should be noted that the speculative access to memory is permitted to proceed even in the presence of an indication in coherence directory 200 that a cached copy of the target memory block is held by a processor 102 in one of L2 caches 106.

Block 420 depicts PQ 204 mastering a reflected bus read request specifying the target memory address on the processor bus 109 (e.g., processor bus 109b) of the processor 102 associated by coherence directory 200 with the E coherency state (also shown at reference numeral 218 of FIG. 2). For clarity, this processor bus 109b is referred to herein as the “alternative processor bus.” In addition, PQ 204 monitors the snoop phases on the alternative processor bus 109b (as also shown at reference numeral 220 of FIG. 2) for the snoop response to the reflected bus read request (FIG. 2, reference numeral 222) and for a collision, if any, between the target memory address of the reflected bus read request and that of another memory access request occurring prior to receipt by PQ 204 of the snoop response of the reflected bus read request.

The monitoring depicted at block 420 can have three outcomes, which are collectively represented by the outcomes of decision blocks 422 and 424. In particular, if PQ 204 determines at block 422 that the target memory address received a “dirty” snoop response to the reflected bus read request, indicating that the target address is cached in the Modified coherency state by a processor 102 on the alternative processor bus 109b, the process passes through page connector A to block 430 of FIG. 4B, which is described below. Alternatively, if PQ 204 determines at block 422 that no collision was detected and the target memory address received a “clean” snoop response to the reflected bus read request, indicating that the target address is cached, if at all, in the Shared coherency state by a processor 102 on the alternative processor bus 109b, the process passes through page connector B to block 440 of FIG. 4B, which is described below. Alternatively, in response to PQ 204 determining at block 424 that a “clean” snoop response was received for the reflected bus request and that a collision was detected for the target memory address, the process proceeds to block 426 and following blocks, which are described below.

Referring now to block 430 of FIG. 4B, which pertains to the case in which the reflected bus read request received a “dirty” snoop response, PQ 204 provides a data return indication to the requesting processor bus interface 112 to indicate that the next data it receives will be valid. As depicted at block 432, asynchronously to the transmission of the data return indication at block 430, processor bus interface 112b receives an updated copy of the requested memory block from a processor 102 on the alternative processor bus 109b (FIG. 2, reference numeral 224) and, concurrently with buffering the memory block copy within CDB 240, forwards the updated copy of memory block to the requesting processor bus interface 112a. Upon receiving both the data return indication and the requested memory block, requesting processor bus interface 112a initiates a deferred reply on processor bus 109a to complete the transaction, following the standard bus protocol. As indicated at reference numeral 228 of FIG. 2, the bus protocol provides for memory controller 110 to indicate the maximum coherency state the memory block may be assigned in the L2 cache 106 of the requesting processor 102 (e.g., S or E/M).

Following block 432, the process proceeds to block 460, which depicts PQ 204 updating the entry for the target memory address in coherence directory 200 to indicate that the requesting processor 102 holds a Shared copy of the associated memory block. Thereafter, PQ 204 deallocates the PQ entry 206 allocated to the bus read request (block 462), and the process terminates at block 464.

Referring now to block 440 of FIG. 4B, which pertains to the case in which the reflected bus read request received a “clean” snoop response, PQ 204 provides a data return indication to the requesting processor bus interface 112a to indicate that the next data it receives will be valid. As indicated at block 442, asynchronously to the transmission of the data return indication at block 440, memory interface 114 receives a copy of the requested memory block from memory subsystem 130 in response to the speculative fast path read request and, concurrently with buffering the copy of the requested memory block within CDB 240, forwards the copy of the memory block to the requesting processor bus interface 112a (FIG. 2, reference numeral 227). Upon receiving both the data return indication and the requested memory block, processor bus interface 112a initiates a deferred reply on processor bus 109a to complete the transaction, following the standard bus protocol. As indicated at reference numeral 228 of FIG. 2, the bus protocol provides for memory controller 110 to indicate the maximum coherency state the memory block may be assigned in the L2 cache 106 of the requesting processor 102 (e.g., S or E/M).

Following block 442, the process proceeds to block 460, which depicts PQ 204 updating the entry for the target memory address in coherence directory 200 to indicate that the requesting processor 102 holds an Exclusive copy of the associated memory block. Thereafter, the process passes to blocks 462-464, which have been described.

Referring now to block 426, in response to PQ 204 determining that a “clean” snoop response was received for the reflected bus request and that a collision was detected for the target memory address data processing system 100, PQ 204 performs the necessary cleanup operations to appropriately address the collision. Because the cleanup operations involve the cancellation of the speculative memory read request initiated at block 404, PQ 204 thereafter initiates a second non-speculative memory read request for the target memory address, as illustrated at block 428 of FIG. 4A and at reference numeral 226 of FIG. 2.

The process then proceeds through page connector C of FIG. 4A to block 450 of FIG. 4B. Block 450 depicts PQ 204 providing a data return indication to the requesting processor bus interface 109a to indicate that the next data it receives will be valid. As indicated at block 452, asynchronously to the transmission of the data return indication at block 450, memory interface 114 receives a copy of the requested memory block from memory subsystem 130 in response to the non-speculative read request initiated at block 428 and, concurrently with buffering the memory block within CDB 240, forwards the copy of the memory block to the requesting processor bus interface 112a. Upon receiving both the data return indication and the requested memory block, processor bus interface 112a initiates a deferred reply on processor bus 109a to complete the transaction, following the standard bus protocol. As indicated at reference numeral 228 of FIG. 2, the bus protocol provides for memory controller 110 to indicate the maximum coherency state the memory block may be assigned in the L2 cache 106 of the requesting processor 102 (e.g., S or E/M).

Following block 452, the process proceeds to block 460, which depicts PQ 204 updating the entry for the target memory address in coherence directory 200 to indicate that the requesting processor 102 holds a Shared copy of the associated memory block. Thereafter, the process passes to blocks 462-464, which have been described.

Referring now to FIGS. 5A-5B, there is depicted a high level logical flowchart of an exemplary method by which a coherence directory of a data processing system implementing a directory-based coherency protocol processes directory lookup requests in accordance with the present invention. The process will be described with respect to an embodiment in which directory array banks 314 are implemented with a dynamic memory technology, such as eDRAM, which requires a precharge cycle between each access to the same directory array bank 314.

The process begins at block 500 of FIG. 5A in response to coherence directory 200 receiving a directory lookup request from request handler 208 at block 406 of FIG. 4A and as shown at reference numeral 212 of FIG. 2. In response to receipt of the directory lookup request, the address control logic 320 of each directory slice 310 makes a determination, as shown at block 502, of whether the target real memory address is assigned to that directory slice 310. Each instance of address control logic 320 may make the determination depicted at block 502, for example, by hashing the specified target real memory address or by comparing the target real memory address to the contents of one or more address range registers. In response to address control logic 320 determining at block 502 that the target real memory address is not assigned to its directory slice 310, address control logic 320 discards the directory lookup request, and the process terminates at block 503. If, however, an instance of address control logic 320 determines at block 502 that the directory lookup request is for a real memory address assigned to its directory slice 310, the process proceeds to blocks 504 and 506, which depict operations performed at stage 0 of a directory pipeline 326.

Block 504 depicts address control logic 320 enqueuing the directory lookup request in the directory queue (DIRQ) 322 of the directory array bank 314 to which the target real memory address maps. As noted above, in one embodiment, target real memory addresses corresponding to odd multiples of the memory block size (e.g., 128) are assigned to directory array bank 314a, and target real memory addresses corresponding to even multiples of the memory block size are assigned to directory array bank 314b.

As shown at block 506, the recipient directory queue 322 initiates a lookup of the target address in prefetch sector cache 324, preferably in parallel with the enqueuing operation illustrated at block 504. Because the prefetch sector cache 324 is small and implemented utilizing latches (or other high speed storage circuitry), results of the lookup of prefetch sector cache 324 can often be obtained in the same clock cycle that the directory lookup request is enqueued in directory queue 322. If the target real memory address hits in prefetch sector cache 324 at block 508 (e.g., due to the other sector 318 of the same directory entry 316 being recently accessed), prefetch sector cache 324 provides a hit indication and the coherency information for the requested sector 318 to the directory queue 322 (block 510). Following block 510 or in response to a determination at block 508 that the directory lookup request missed in prefetch sector cache 324, processing of the directory lookup request proceeds to stage 1 of the directory pipeline 326.

In stage 1 of the directory pipeline 326, the entry for the directory lookup request is dequeued from directory queue 322 and the directory lookup request dispatched. As indicated at block 520, if the directory lookup request hit in sector prefetch cache 324, the directory lookup request and the contents of the requested sector are dispatched within directory pipeline 326 without regard to whether the associated directory array bank 314 is in a precharge cycle since the directory array bank 314 need not and will not be accessed by this request. Thus, in the case of a hit in prefetch sector cache 324 the directory lookup request is dispatched up to the duration of a full precharge cycle before it otherwise would have been if prefetch sector cache 324 were not accessed. Further, because the directory lookup request bypasses memory array bank 314, an immediately subsequent directory lookup request that requires access to memory array bank 314 can be dispatched a full precharge cycle before it otherwise would have been dispatched because no precharge delay is incurred for the previous directory lookup request that hit in sector prefetch cache 324. Following block 520, the process proceeds to block 528, which is described below.

If, on the other hand, the directory lookup request missed in sector prefetch cache 324, as indicated by the absence of a hit indication, the dispatch of the directory lookup request is delayed if a bank precharge cycle is being performed for the associated memory array bank 314, as depicted at block 522. Once the bank precharge cycle, if any, is complete, the directory lookup request is dispatched without a hit indication. In response to the directory lookup request not having a hit indication, the stage 1 of directory pipeline 326 allocates a new entry in prefetch sector cache 324 to hold the non-requested sector 318 after retrieval from directory array bank 314, as shown at block 526.

Following block 520 or block 526, the process proceeds to block 528, which illustrates the stage 1 of directory pipeline examining the directory lookup request and initiating access to the associated directory array bank 314, if the directory lookup request does not contain a hit indication indicating that the contents of requested sector were obtained from sector prefetch cache 324. Thereafter, the process passes through page connector A to block 530 and following blocks of FIG. 5B.

Blocks 530-550 of FIG. 5B depict the operation of stages 2-4 of the directory pipeline 326. During stages 2-4 (and preferably as late as possible given the access latencies of local buffer 330 and scalability buffer 332), directory pipeline 326 accesses local buffer 330 and scalability buffer 332 utilizing the target memory address specified by the directory lookup request (blocks 530 and 540). The lookups in local buffer 330 and scalability buffer 332 are preferably, but not necessarily performed concurrently. As shown at blocks 532, 542 and 544, if the directory lookup request hits in either local buffer 330 or scalability buffer 332, the contents of the requested sector supplied by the buffer in which the hit occurred are transmitted in directory pipeline 326 along with the direct lookup request.

Following block 544 or a negative determination at block 532 or 542, the process passes to block 550. Block 550 represents directory pipeline 326 continuing to track the directory lookup request while awaiting results of the lookup, if any, performed in directory array bank 314.

Following the processing at stages 2-4, the directory lookup request is processed by a result buffer 336 at stage 5 of directory pipeline 326, as depicted at blocks 560-568. At block 560, result buffer 336 determines whether the memory bank array 314 was accessed to service the directory lookup request. If not, result buffer 336 simply merges the coherency results obtained from the lookups in sector prefetch cache 324, local buffer 330 and scalability buffer 332 and returns the result to PQ 204 as the result of the directory lookup request, as shown at block 566. Thereafter, the process terminates at block 568.

Returning to block 560, if directory array bank 314 was accessed to service the directory lookup request, result buffer 336 receives both the requested and non-requested sectors 318a, 318b in the relevant directory entry 316, as shown at block 562 In response to receipt of the contents of the directory entry 316, result buffer 336 stores the contents of the non-requested sector 318 in sector prefetch cache 324 in association with the target real memory address via directory bus 340 (block 564). As previously explained with referenced to blocks 508-510, placing the contents of the non-requested sector 318 in sector prefetch cache 324 permits subsequent directory lookup requests for such sectors 318 to be serviced at reduced access latency. As depicted at block 566, result buffer 336 merges the contents of the requested sector 318 obtained from memory array bank 314 with the results obtained from the lookups in local buffer 330 and scalability buffer 332 and returns the result to PQ 204 as the result of the directory lookup request. Thereafter, the process terminates at block 568.

Merging coherency results in directory pipeline 326 in the above-described manner ensures that any directory updates that occur while a request is in-flight update superseded results provided by the local buffer 330 and scalability buffer 332. In addition, merging the directory results as described above enables coherence directory 200 to handle cases in which back-to-back requests target the same directory entry 316. In such cases, the first directory lookup request causes the allocation an entry in sector prefetch cache 324, and the second request hits in sector prefetch cache 324. However, sector prefetch cache 324 will not contain the valid coherency state results for the second request until the lookup in memory directory array 314 caused by the first request completes. Despite this fact, the second request flows down the pipeline as if it had results, and the results from the first lookup request are merged into the second lookup request at or before the end of the directory pipeline 326.

As has been described, the present invention provides improved methods, apparatus and systems for data processing in a data processing system. According to one aspect of the present invention, directory access latency is reduced for a sectored directory by utilizing a sector prefetch cache to temporarily cache non-requested sectors of directory entries for which the coherency information is likely to soon be requested. It will be appreciated that in implementations in which dynamic memory technology is utilized to implement the memory directory array, access latency is reduced by up to the duration of a precharge cycle because accessing a requested sector in the prefetch sector cache eliminates the need to wait for a precharge cycle to complete before the directory access request is processed. In addition, the directory access latency of a subsequent read or update access to the same memory directory bank/array is reduced because a precharge cycle (and its concomitant latency) is eliminated, regardless of whether the subsequent access is for the same directory entry.

In at least some embodiments of the present invention, directory access latency can be further reduced by permitting the results of the lookup in prefetch sector cache 324 to bypass directory pipeline 326, for example, by transmitting the contents of a requested sector from prefetch sector cache 324 to result buffer 336 via directory bus 340. In this manner, some or all of the latency associated with processing at the various stages of directory pipeline 326 is also eliminated.

While the invention has been particularly shown as described with reference to a preferred embodiment, it will be understood by those skilled in the art that various changes in form and detail may be made therein without departing from the spirit and scope of the invention. For example, although aspects of the present invention have been described with respect to a data processing system hardware components that perform the functions of the present invention, it should be understood that present invention may alternatively be implemented partially or fully in software or firmware program code that is processed by data processing system hardware to perform the described functions. Program code defining the functions of the present invention can be delivered to a data processing system via a variety of computer-readable media, which include, without limitation, non-rewritable storage media (e.g., CD-ROM or non-volatile memory), rewritable storage media (e.g., a floppy diskette or hard disk drive), and communication media, such as digital and analog networks. It should be understood, therefore, that such computer-readable media, when carrying or encoding computer readable instructions that direct the functions of the present invention, represent alternative embodiments of the present invention.

In addition, while the present invention has been described with reference to an exemplary embodiment in which entries 316 in directory array banks 318 include two sectors, those skilled in the art will appreciate that the present invention is also applicable to embodiments including additional sectors within entries 316. In such embodiments, multiple non-requested sectors are cached in an entry of prefetch sector cache 324 in response to an access to an entry 316 in a directory array bank 314.

What is claimed is:

1. A method of servicing directory lookup requests in a data processing system including a coherence directory having a prefetch sector cache and having a memory directory array containing a plurality of entries, wherein each entry includes multiple sectors, said method comprising:
in response to receiving a first directory lookup request specifying a first target address, the coherence directory:
accessing an entry associated with the first target address in the memory directory array;
returning, as a result of the first directory lookup request, contents of a first sector that is identified by the first target address as a requested sector; and
caching contents of a second sector of the multiple sectors that is a non-requested sector for the first directory lookup request in a prefetch sector cache; and
in response to receiving a subsequent second directory lookup request specifying a second target address that identifies the second sector as a requested sector, the coherence directory accessing the contents of the second sector in the sector prefetch cache and returning the contents of the second sector as a result of the second directory lookup request.

2. The method of claim 1, and further comprising:
said coherence directory servicing said second directory lookup request without accessing the memory directory array.

3. The method of claim 2, wherein:
said coherence directory includes a multi-cycle directory pipeline supporting access to the memory directory array; and
returning the contents of the second sector as a result of the second directory lookup request includes bypassing the directory pipeline with the contents of the second sector.

4. The method of claim 1, wherein:
the memory directory array includes a plurality of banks; and
said method further comprises the coherence directory selecting a particular one of said plurality of banks that contains said entry as a bank to be accessed based upon said first target address.

5. The method of claim 1, and further comprising:
invalidating the contents of the second sector in the prefetch sector cache in response to a directory update request.

6. The method of claim 1, and further comprising buffering contents of recently requested sectors in a buffer within the coherence directory.

7. The method of claim 1, wherein:
the coherence directory includes a directory queue; and
the method further comprises determining if said second directory lookup request hit in said sector prefetch cache concurrently with enqueuing the second directory lookup request in said directory queue.

8. The method of claim 1, and further comprising replacing contents of the prefetch sector cache utilizing a First-In, First-Out replacement policy.

9. The method of claim 1, wherein:
said entry associated with the first target address includes at least a third sector that is a non-requested sector for the first directory lookup request; and
said method further comprises caching contents of the third sector in the prefetch sector cache in response to the first directory lookup request.

10. A memory controller for a memory in a data processing system, said memory controller comprising:
a processor interface;
a memory interface coupled to the memory;
a coherence directory including:
a memory directory array including a plurality of sectored entries that store cache states of memory blocks in the memory, where each of said plurality of entries includes a first sector and a second sector; and
a prefetch sector cache that, responsive to receipt by the coherence directory of a first directory lookup request that identifies the first sector of a particular entry as a requested sector, receives and caches the second sector of the particular entry that is non-requested by the first directory lookup request, and thereafter, in response to receipt by the coherence directory of a second directory lookup request that identifies the second sector as a requested sector, outputs the contents of the second sector to service the second directory lookup request.

11. The memory controller of claim 10, wherein the coherence directory services the second directory lookup request without accessing the memory directory array.

12. The memory controller of claim 11, wherein:
said coherence directory includes a multi-cycle directory pipeline supporting access to the memory directory array; and
the prefetch sector cache outputs the contents of the second sector as a result of the second directory lookup request while bypassing the directory pipeline.

13. The memory controller of claim 10, wherein:
the memory directory array includes a plurality of banks; and
the coherence directory includes address control logic that selects a particular one of said plurality of banks that contains said entry as a bank to be accessed based upon said first target address.

14. The memory controller of claim 10, wherein the coherence directory invalidates the contents of the second sector in the prefetch sector cache in response to a directory update request.

15. The memory controller of claim 10, said coherence directory further comprising a buffer that buffers contents of recently requested sectors.

16. The memory controller of claim 10, wherein:
the coherence directory includes a directory queue; and
the coherence directory determines if said second directory lookup request hit in said sector prefetch cache concurrently with enqueuing the second directory lookup request in said directory queue.

17. The memory controller of claim 10, wherein said sector prefetch cache is formed of latches.

18. The memory controller of claim 10, wherein said prefetch sector cache implements a First-In, First-Out replacement policy.

19. The memory controller of claim 10, wherein:
said entry associated with the first target address includes at least a third sector that is a non-requested sector for the first directory lookup request; and
the prefetch sector cache caches the third sector in response to the first directory lookup request.

20. A multiprocessor data processing system, comprising:
multiple processors;
a memory subsystem; and
a memory controller coupled to the multiple processors and the memory subsystem, said memory controller including a central coherence directory that records cache states of the multiple processors with respect to memory blocks of the memory subsystem, wherein said coherence directory includes:
a memory directory array including a plurality of sectored entries that store cache states of memory blocks in the memory, where each of said plurality of entries includes a first sector and a second sector; and
a prefetch sector cache that, responsive to receipt by the coherence directory of a first directory lookup request that identifies the first sector of a particular entry as a requested sector, receives and caches the second sector of the particular entry that is non-requested by the first directory lookup request, and thereafter, in response to receipt by the coherence directory of a second directory lookup request that identifies the second sector as a requested sector, outputs the contents of the second sector to service the second directory lookup request.

21. The data processing system of claim 20, wherein the coherence directory services the second directory lookup request without accessing the memory directory array.

22. The memory controller of claim 21, wherein:
said coherence directory includes a multi-cycle directory pipeline supporting access to the memory directory array; and
the prefetch sector cache outputs the contents of the second sector as a result of the second directory lookup request while bypassing the directory pipeline.

23. The data processing system of claim 20, wherein:
the memory directory array includes a plurality of banks; and
the coherence directory includes address control logic that selects a particular one of said plurality of banks that contains said entry as a bank to be accessed based upon said first target address.

24. The data processing system of claim 20, wherein the coherence directory invalidates the contents of the second sector in the prefetch sector cache in response to a directory update request.

25. The data processing system of claim 20, said coherence directory further comprising a buffer that buffers contents of recently requested sectors.

26. The data processing system of claim 20, wherein:
the coherence directory includes a directory queue; and
the coherence directory determines if said second directory lookup request hit in said sector prefetch cache concurrently with enqueuing the second directory lookup request in said directory queue.

27. The data processing system of claim 20, wherein said sector prefetch cache is formed of latches.

28. The data processing system of claim 20, wherein:
said entry associated with the first target address includes at least a third sector that is a non-requested sector for the first directory lookup request; and
the prefetch sector cache caches the third sector in response to the first directory lookup request.
